(19) United States
(12) Patent Application Publication
(10) Pub. No.: US 2026/0322612 A1
(43) Pub. Date: Oct. 15, 2026

(54) Physical Blockchain Security Architecture

(71) Applicant: Sidney Wilson, JR., Jackson, TN (US)

(72) Inventor: Sidney Wilson, JR., Jackson, TN (US)

(21) Appl. No.: 19/288,251

(22) Filed: Aug. 1, 2025

Related U.S. Application Data
(60) Provisional application No. 63/834,713, filed on Apr. 14, 2025.

(51) Int. Cl. H04L 9/32; H04L 9/00

(52) U.S. Cl. CPC H04L 9/3231; H04L 9/50

(57) ABSTRACT

A secure cryptocurrency system comprising a tamper-resistant hardware device that generates dynamic passwords at predetermined time intervals while maintaining encrypted storage of authentication credentials. The device integrates multiple biometric sensors including fingerprint, retinal scan, and heartbeat pattern recognition to provide multi-modal authentication that eliminates static password vulnerabilities. The system stores devices in secure vault facilities at financial institutions with controlled access, creating “multiple redundancies across different locations” for continuity. A biometric fusion processor generates unified authentication decisions based on user-configurable security thresholds, implementing “tiered security” that varies access permissions based on cryptocurrency transaction amounts. The device includes fail-safe mechanisms that automatically disable upon tampering detection. Dynamic passwords display temporarily before automatically hiding, enabling “checking account functionality” through banking infrastructure integration while maintaining offline security.

### RELATED APPLICATION

This application claims the benefit of priority of U.S. Provisional application 63/834,713, filed Apr. 14, 2025. The contents of that application are incorporated in its entirety herein.

### TECHNICAL FIELD

Embodiments described herein generally relate to computer distributed ledger security and, in some embodiments, more specifically to a physical blockchain security architecture.

### BACKGROUND

Cryptocurrency security systems conventionally rely on static password authentication and single-modality security measures that create fundamental vulnerabilities in digital asset protection. Conventional hardware wallets and software-based cryptocurrency management systems typically employ fixed credentials that remain constant until manually changed by users, creating persistent attack vectors for malicious actors. Additionally, existing biometric authentication systems generally utilize single biometric modalities, which suffer from accuracy limitations, spoofing vulnerabilities, and insufficient security for high-value cryptocurrency transactions. The distributed nature of cryptocurrency networks has also created challenges in integrating with conventional financial infrastructure, limiting mainstream adoption and institutional-grade security implementations.

These conventional approaches suffer from several critical technical limitations that compromise cryptocurrency security and usability. Static password systems are inherently vulnerable to theft, interception, and coercion attacks, where users can be physically threatened to reveal their credentials. Single-point authentication failures create security weaknesses that can result in complete loss of cryptocurrency assets with no recovery mechanisms. Furthermore, the technical complexity and isolation of cryptocurrency systems from conventional banking infrastructure has created barriers to mainstream adoption, as users lack familiar institutional frameworks for secure storage and transaction processing. The absence of integrated multi-modal authentication systems and dynamic credential management has left cryptocurrency holders exposed to sophisticated attacks that exploit the permanent nature of conventional password-based security.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a block diagram of an example of an environment and a system for physical blockchain security architecture, according to an embodiment.

FIG. 2 illustrates a flow diagram of an example of an authentication process for a physical blockchain security architecture, according to an embodiment.

FIG. 3 illustrates a flow diagram of an example of a biometric fusion process for a physical blockchain security architecture, according to an embodiment.

FIG. 4 illustrates a flow diagram of an example of a tiered security assessment process for a physical blockchain security architecture, according to an embodiment.

FIG. 5 illustrates a flow diagram of an example of a password generation and display process for a physical blockchain security architecture, according to an embodiment.

FIG. 6 illustrates an example of a method for a physical blockchain security architecture, according to an embodiment.

FIG. 7A and FIG. 7B illustrate an example of a secure hardware device for a physical blockchain security architecture, according to an embodiment.

FIG. 8 is a block diagram illustrating an example of a machine upon which one or more embodiments may be implemented.

### DETAILED DESCRIPTION

Conventional cryptocurrency security systems require users to know and remember their authentication credentials, creating vulnerability to coercion and forced disclosure. The systems and techniques discussed herein use a dynamic password device that conceals passwords until specific security requirements are satisfied. The dynamic password device hides the password and only displays it for a limited period of time (e.g., 30 seconds, 60 seconds, etc.) after the user satisfies predetermined security measures. This approach eliminates the need for a user to know the password, making coercion ineffective because the user cannot provide the password that the user does not know.

Existing security devices use single-factor authentication methods that can be compromised or bypassed. The system and techniques discussed herein use a configurable multi-layered biometric authentication architecture that allows users to set a desired security level. The dynamic password device incorporates multiple biometric verification capabilities including, but not limited to fingerprint scanning, retinal scanning, heartbeat authentication, and full body scanning. Users can enable multiple security features is various orders and determine a level of authentication required. In an example, a user can set a policy that triggers additional verification steps at different thresholds (e.g., transaction value, location, etc.

Cryptocurrency security devices that connect to the internet are subject to network-based attack vectors and remote compromise risks. The systems and techniques discussed herein enable offline operation. The dynamic password device does not require internet connectivity for core security functions to maintain air-gapped operation to prevent remote attacks. The dynamic password device generates and manages authentication credentials internally without external communication requirements.

Current cryptocurrency security solutions lack integration with conventional banking infrastructure, limiting mainstream adoption and institutional-grade storage options. The system addresses this through a bank-integrated storage framework where the security devices are housed in financial institution vaults, similar to conventional safe deposit boxes. This integration provides controlled access during banking hours (e.g., 8 am-5 pm, etc.) while maintaining physical security through established banking infrastructure. The approach bridges cryptocurrency systems with familiar banking services, enabling conventional financial institutions to participate in digital asset security.

Security devices must maintain continuous operation while remaining portable and user manageable. The systems and techniques discussed herein use a user-replaceable power sources (e.g., a non-rechargeable battery, a rechargeable battery, etc.), eliminating dependence on external charging infrastructure. The dynamic password device retains all stored information even when power is depleted, ensuring data persistence across power cycles. Banking partners can optionally provide charging capabilities within safe deposit storage areas, though this is not required for system operation.

Static security systems cannot adapt to varying risk levels associated with different transaction amounts or user preferences. The system implements a tiered security architecture where authentication requirements scale based on user-configured parameters. Users can set different security thresholds for various cryptocurrency amounts, requiring minimal authentication for small transactions while demanding comprehensive biometric verification for larger amounts. This configurable approach allows personalized security policies that balance usability with protection requirements.

Single-point-of-failure risks in cryptocurrency security can result in permanent loss of access to digital assets. The system addresses this through a redundant storage network where users can maintain multiple dynamic password devices across different institutional locations. This distributed approach ensures continuity of access even if one storage location becomes unavailable due to natural disasters, institutional failures, or other disruptions. Users maintain control over redundancy decisions while the system supports multi-location deployment.

The secure cryptocurrency system comprises a physical dynamic password device that fundamentally transforms how users interact with their digital assets by eliminating the need for password knowledge while providing institutional-grade storage and authentication. The system centers around a compact dynamic password device, approximately the size of a USB stick, that conceals cryptocurrency passwords until predetermined security requirements are satisfied. This dynamic password device operates on the principle that users cannot be coerced into revealing information they do not possess. The dynamic password device maintains complete offline operation capabilities, never requiring internet connectivity for core security functions, though it retains optional connectivity features that are not recommended for standard implementation.

The system implements a sophisticated multi-tiered biometric authentication architecture that allows users to configure security levels based on their specific requirements and risk tolerance. Authentication methods include fingerprint verification, retinal scanning, heartbeat authentication, full body scanning, and conventional password options, which can be stacked in various combinations according to user preferences. The dynamic password device displays the concealed password for a limited time period of 60 seconds after successful authentication, with this duration being adjustable to shorter or longer periods as needed. Security requirements can be scaled based on transaction amounts, with users able to set minimal authentication for small cryptocurrency movements while requiring comprehensive biometric verification for larger transactions. The dynamic password device maintains a six-month battery life with user-replaceable power sources and retains all stored information even when power is depleted, ensuring data persistence across power cycles.

A critical component of the system involves integration with conventional banking infrastructure, where the security devices are stored in financial institution vaults similar to conventional safe deposit boxes. This institutional storage approach provides controlled access during standard banking hours (8 am-5 pm) while leveraging established banking security protocols and physical infrastructure. The system supports redundant storage locations across multiple banking institutions, allowing users to maintain backup dynamic password devices at different facilities to ensure continuity of access in case of natural disasters, institutional failures, or other disruptions. This banking integration creates new revenue opportunities for financial institutions through safe deposit box rentals, account management fees similar to checking accounts, and lending services for excess cryptocurrency holdings. The approach bridges the gap between conventional banking services and cryptocurrency systems, enabling familiar institutional frameworks for digital asset management while providing the security infrastructure necessary for mainstream cryptocurrency adoption.

The user begins by configuring the dynamic password device at home, where the user can establish desired security parameters without any external connectivity requirements. During initial setup, the user determines the level of security they want to implement by selecting from available biometric authentication options including fingerprint verification, retinal scanning, heartbeat authentication, full body scanning, or conventional password entry. The user can stack multiple security features according to their preferences, with the system allowing configuration of different security thresholds based on cryptocurrency amounts-requiring minimal authentication for small transactions while demanding comprehensive biometric verification for larger amounts. The device does not link to the user's cryptocurrency accounts in any way during this setup process, maintaining complete independence from external systems.

Following initial configuration, the user transports the device to a participating banking institution where it is stored in a secure facility, typically in safe deposit boxes or specialized storage containers provided by the bank. The banking institution provides controlled access to the device during standard banking hours from 8 am to 5 pm, ensuring that emergency transactions must wait until the bank is open as an additional security feature. Users may choose to store multiple devices at different banking locations to provide redundancy in case of institutional failures, natural disasters, or other disruptions, though this decision remains entirely at the user's discretion.

When the user needs to access their cryptocurrency, they visit the banking institution during operating hours and retrieve their device from secure storage. The user then initiates the authentication sequence by satisfying the predetermined security measures they configured during initial setup. The device conceals the password until all required biometric verifications are completed, which may include any combination of the configured authentication methods such as fingerprint scanning, retinal verification, or other biometric factors. Once the security requirements are satisfied, the device displays the password for a limited time period (e.g., 60 seconds, a user selectable time between 30 and 120 seconds, etc.), though this duration can be adjusted to shorter or longer periods based on user preferences. After the display period expires, the password is automatically concealed again, requiring the user to repeat the authentication process for subsequent access.

The device may operate on a six-month battery cycle, with users responsible for replacing the battery every six months as recommended. If the battery is not replaced within the suggested timeframe and the device loses power, all stored information is retained and will be restored when the system is recharged. Banking institutions may optionally provide charging capabilities within the safe deposit storage areas, though this is not required for normal system operation. The device maintains complete offline operation throughout its lifecycle, never requiring internet connectivity for core security functions, though it retains optional connectivity features that are not recommended for standard implementation.

The system incorporates sophisticated backup power sources including rechargeable batteries and supercapacitors with secure charging interfaces housed within the bank vault or storage facility infrastructure. The rechargeable battery system provides extended operational capability while supporting secure charging protocols that prevent power-based attacks. Supercapacitor backup systems provide immediate power during charging transitions and emergency situations to maintain cryptographic state and security functions. The secure charging interface implements authenticated charging protocols that verify the legitimacy of charging sources and prevent malicious power injection attacks. Power management algorithms optimize energy consumption while maintaining security functions and providing early warning of power depletion to ensure continuous operation.

The system implements anti-coercion measures by ensuring that users never possess knowledge of their actual passwords, making forced disclosure impossible since the user cannot provide information they do not know. The controlled access hours of a banking institution serve as an additional security layer, preventing unauthorized access during non-banking hours and requiring physical presence at the institution for device retrieval. For users requiring different levels of access, the tiered security architecture allows varying authentication requirements-for very low levels of cryptocurrency, users may require no security measures, while larger amounts may demand multiple biometric verifications. The offline operation of the device eliminates network-based attack vectors while the institutional storage provides physical security through established banking infrastructure.

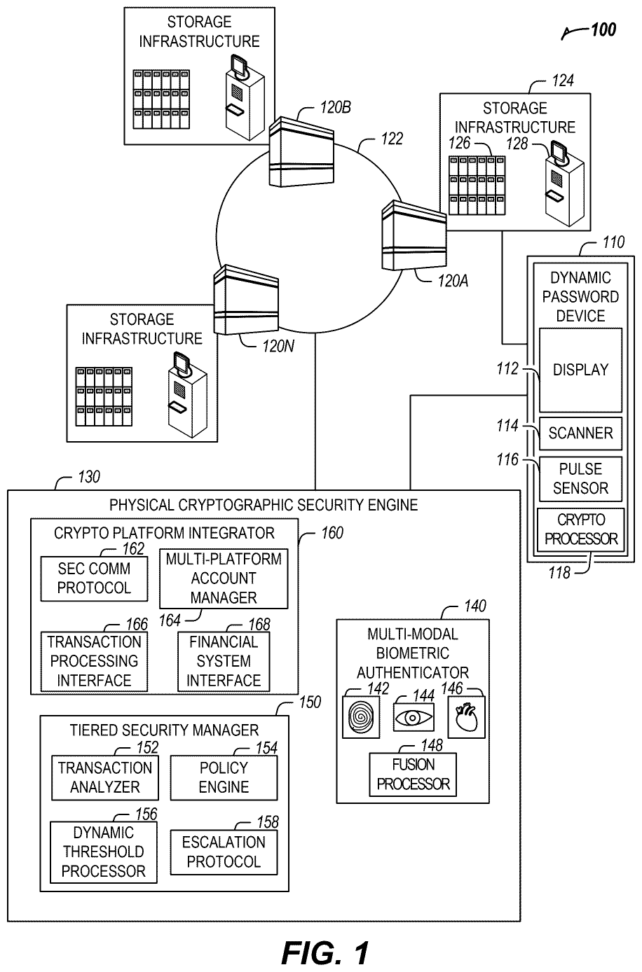

FIG. 1 is a block diagram of an example of an environment 100 and a system 130 for physical blockchain security architecture, according to an embodiment.

A dynamic password manager device 110 is a compact hardware device (e.g., approximately the size of a portable flash drive, etc.) that houses a temporal display 112, advanced biometric sensors, such as a scanner 114 (e.g., a fingerprint scanner, a retina scanner, etc.) and a pulse sensor 116 (e.g., a heart rate sensor, etc.), and a secure cryptographic processor 118. The dynamic password manager device 110 can contain multiple integrated biometric authentication modules including a fingerprint scanner, retinal scanning camera, heartbeat pattern sensor, etc. that work in combination to provide multi-modal authentication. The dynamic password manager device 110 incorporates the secure cryptographic processor 118 that generates dynamic passwords at predetermined intervals (e.g., every few seconds, etc.) while maintaining encrypted storage of authentication credentials.

A tamper-resistant housing surrounds the internal components of the dynamic password manager device 110 and includes fail-safe mechanisms that automatically disable the dynamic password manager device 110 if physical tampering is detected or if the dynamic password manager device 110 is removed from its secure environment. The dynamic password manager device 110 also includes the temporal display 112 that presents passwords to authorized users for a configurable time period (e.g., 60 seconds, 30 seconds, etc.) before automatically hiding the information to enhance security.

The secure cryptographic processor 118 incorporates a dedicated hardware security module (HSM) with embedded firmware specifically configured for secure key storage and time-based password generation operations. The HSM provides tamper-resistant hardware that protects cryptographic keys and sensitive operations from physical and logical attacks, implementing secure boot processes and authenticated firmware updates. The embedded firmware includes optimized algorithms for hierarchical key derivation functions and time-based one-time password generation that maintain cryptographic security while operating in the offline environment described in the base invention. The HSM architecture ensures that cryptographic operations occur within a secure boundary that prevents key extraction even under sophisticated attack scenarios.

The secure cryptographic processor 118 employs an advanced spliced key architecture where portions of cryptocurrency private keys are distributed between hardware secure elements within the device and the biometric authentication infrastructure, requiring temporary secure pairing for transaction processing. The key splitting algorithms utilize cryptographic secret sharing techniques that ensure no single component contains sufficient information to reconstruct the complete private key. Hardware secure elements within the device store encrypted key portions using tamper-resistant storage that prevents extraction even under physical attack. The biometric authentication infrastructure maintains complementary key portions in secure banking systems that are only accessible through authenticated biometric verification. Temporary pairing protocols utilize advanced cryptographic techniques to reconstruct private keys only during authorized transactions, immediately destroying the reconstructed keys after use to maintain security.

The secure cryptographic processor 118 performs sophisticated hierarchical key derivation functions (HKDF) to generate session-specific passwords that enhance resilience against replay attacks and side-channel attacks. The HKDF implementation utilizes cryptographically secure algorithms that derive unique session keys from master key material while maintaining forward secrecy and backward secrecy properties. Session-specific password generation ensures that each authentication session utilizes unique cryptographic material that cannot be reused or replayed in subsequent sessions. Side-channel attack resistance is achieved through constant-time cryptographic operations and power analysis countermeasures that prevent information leakage through timing or power consumption patterns. Additional countermeasures against fault injection attacks and other advanced cryptographic attacks are used while maintaining operational efficiency.

The tamper detection mechanism incorporates comprehensive environmental sensors including vibration detectors, electromagnetic interference monitors, and chemical sensors that provide multi-layered physical security protection. Vibration sensors detect unauthorized movement, drilling, or physical manipulation attempts with high sensitivity and low false-positive rates. Electromagnetic interference detectors identify attempts to use electronic tools or devices to compromise the hardware through side-channel attacks or electronic manipulation. Chemical sensors detect the presence of solvents, acids, or other substances that might be used to compromise the device housing or internal components. Upon detection of any tampering attempt, the system immediately executes automatic cryptographic key destruction and complete data erasure protocols that render the device permanently inoperable while protecting sensitive information from unauthorized access.

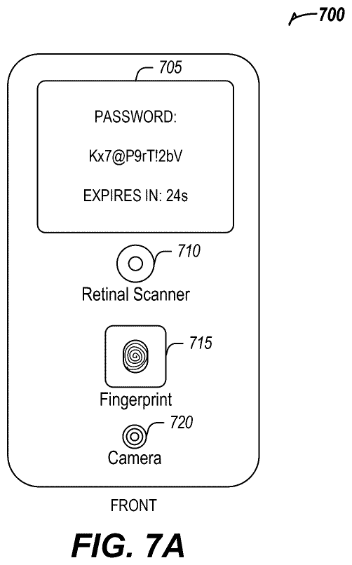

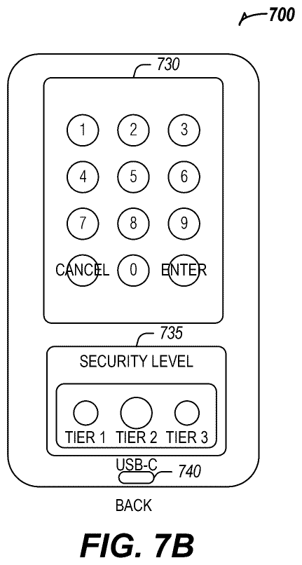

The dynamic password manager device 110 can be implemented in various form factors beyond the example USB stick design. Another example is shown in FIGS. 7A and 7B. Additionally or alternatively, wearable device implementations may integrate the biometric sensors and cryptographic processor into smartwatch-style devices or fitness tracker form factors that provide convenient user access while maintaining security. Compact key fob implementations utilize miniaturized components to create pocket-sized devices that retain full functionality while maximizing portability. Smart card implementations embed the biometric sensors and cryptographic processor within standard credit card form factors, enabling integration with existing payment infrastructure while providing enhanced security features. Each form factor maintains the functionality of dynamic password generation, multi-modal biometric authentication, and tamper-resistant security while adapting to different user preferences and deployment scenarios.

The dynamic password manager device 110 can include wireless communication circuitry that enables secure near-field communication (NFC), Bluetooth®, or cellular connectivity for optional communication with authorized systems while maintaining offline operation. The wireless capabilities are implemented with strict security protocols that ensure primary security functions remain operational when communication capabilities are disabled. NFC implementation enables secure short-range communication for transaction authorization and device pairing with banking terminals. Bluetooth® connectivity provides encrypted communication channels for integration with mobile devices and banking infrastructure while maintaining air-gapped security for core cryptographic operations. Cellular connectivity enables emergency communication and remote monitoring capabilities while preserving the offline security posture that prevents remote attacks on the authentication system.

The dynamic password manager device 110 generates and displays specialized one-time passwords (OTPs) that are cryptographically tied to specific transaction requests, providing enhanced protection against replay attacks beyond the time-based password generation described in the base invention. Each OTP incorporates transaction-specific parameters including recipient addresses, transaction amounts, and timestamp information into the cryptographic generation process. The dynamic password manager device 110 utilizes advanced cryptographic binding techniques that ensure OTPs cannot be reused for different transactions or replayed at later times. Transaction-specific cryptographic signatures are embedded within each OTP to provide mathematical proof of transaction authorization that can be verified by receiving systems. This approach eliminates the possibility of password interception and reuse while maintaining the temporal security benefits of the dynamic password system.

The dynamic password manager device 110 supports sophisticated multi-user profiles that allow multiple authorized users to access the device with individualized biometric criteria and security policies tailored to requirements and authorization levels for each user. Individual user profiles maintain separate biometric templates, authentication thresholds, and transaction authorization limits that prevent cross-user access while enabling shared device usage. Biometric criteria customization allows each user to configure their preferred authentication modalities and security levels based on their individual characteristics and security needs. Security policy individualization enables different users to have varying levels of access to cryptocurrency accounts and transaction capabilities based on their authorization levels and organizational roles. Strict separation is maintained between user profiles while enabling efficient device sharing in appropriate scenarios.

Backup devices are provisioned with different biometric configurations and security policies to ensure that failure of one device does not compromise overall access while maintaining security consistency. Biometric configuration differentiation involves utilizing different sensor combinations, threshold settings, and authentication algorithms across backup devices to prevent common-mode failures. Security policy variation ensures that backup devices can provide equivalent security levels through different authentication pathways, maintaining user access even when specific biometric modalities become unavailable. Intelligent failover algorithms are used that automatically select appropriate backup devices based on available biometric modalities and current security requirements. Cross-device security validation ensures that backup devices maintain equivalent security levels while providing alternative access pathways for users.

A collection of storage facilities such as storage facilities 120A, 120B, and 120N are interconnected via a secure communication network 122 (e.g., private network, secure internet connection, wireless network, local area network, wide area network, etc.). Each storage facility includes a secure storage infrastructure 124 that includes individual secure storage compartments 126 and a biometric access terminal 128. In an example, a storage facility may be a financial institution, a safe deposit vault, a secure storage bank kiosk, or any suitable structure providing physically secure storage. The physical storage and access control for the dynamic password manager device 110 is provided based on the security features and physical access hours provided by the facility. This allows a user to select a physical location based on available security features. The secure storage compartments 126 can have access hours similar to traditional safe deposit boxes that house the password devices while maintaining controlled access during specified operating hours, typically while staff is present. The biometric access terminal 128 interfaces with the stored dynamic password manager device 110 to enable user authentication without removing the devices from their secure environment. Multiple redundant locations (e.g., storage facilities 120A, 120B, and 120N, etc.) across different geographic regions ensure system availability and protect against localized disasters or security breaches. The secure communication network 122 enables integration with cryptocurrency platforms while maintaining the offline security posture of the stored devices.

The secure storage compartments 126 implement comprehensive multi-layer physical security including environmental controls, alarm systems, and tamper-evident seals with both remote and on-site monitoring capabilities. Environmental control systems maintain optimal temperature, humidity, and atmospheric conditions to preserve device integrity and prevent environmental attacks. Integrated alarm systems provide immediate notification of unauthorized access attempts, environmental anomalies, or security breaches through multiple communication channels. Tamper-evident seals utilize advanced materials and detection technologies that provide clear evidence of any unauthorized access while maintaining ease of legitimate access for authorized users. Remote monitoring systems enable continuous surveillance and immediate response to security events, while on-site monitoring provides additional verification and physical security presence during banking hours.

The multiple secure storage locations are strategically positioned across different geographic regions and interconnected through a secure, encrypted wide-area network that supports real-time synchronization of backup credentials and system state information. Geographic separation ensures that natural disasters, regional infrastructure failures, or localized security incidents cannot compromise availability. The secure wide-area network utilizes advanced encryption protocols and authenticated communication channels that protect data in transit while enabling necessary synchronization operations. Real-time synchronization protocols ensure that backup credentials, user profiles, and system configurations remain consistent across all locations while maintaining security and preventing unauthorized access. The network architecture implements redundant communication paths and failover mechanisms that ensure continuous connectivity even during partial network failures.

The biometric access terminal 128 and the dynamic password manager device 110 interact with the system 130. In an example, the system 130 is a physical cryptographic security engine. The system 130 includes a variety of components including a multi-modal biometric authenticator 140, a tiered security manager 150, and a cryptocurrency platform integrator 160. The multi-modal biometric authenticator 140 includes a biometric fusion processor 148 that combines inputs received from a variety of biometric authentication subsystems including a fingerprint authenticator 142, a retinal authenticator144, and a heartbeat authenticator 146. The biometric fusion processor 148 processes and fuses data from multiple of these biometric sensors to create unified authentication decisions that enhance security beyond single-modality systems. The fingerprint authenticator 142 captures and analyzes fingerprint minutiae patterns using advanced sensor technology integrated within the biometric access terminal 128 and the dynamic password manager device 110. The retinal authenticator 144 employs specialized camera technology to capture and verify unique retinal vascular patterns for high-security authentication. The heartbeat authenticator 146 monitors cardiac rhythm signatures to provide an additional biometric factor that is difficult to spoof or replicate.

A comprehensive multi-phase enrollment process is used where biometric data and security preferences are securely stored in a centralized management platform that enables multi-device synchronization across the distributed banking infrastructure. The enrollment process begins with secure biometric template capture using high-quality sensors that ensure accurate representation of user characteristics while implementing privacy protection measures. Security preference configuration allows users to customize authentication requirements, transaction thresholds, and risk tolerance settings according to their individual needs. The centralized management platform utilizes encrypted storage and secure communication protocols to maintain user profiles while enabling synchronization across multiple devices and banking locations. Multi-device synchronization ensures that user preferences and biometric templates are consistently available across the distributed system while maintaining security and privacy protection.

The biometric fusion processor 148 combines data from available authentication modalities using real-time processing algorithms to generate authentication decisions based on user-configurable security thresholds. The multi-modal biometric authenticator 140 allows users to customize security levels by selecting which biometric factors are required for different transaction amounts or security scenarios. The biometric fusion processor 148 implements sophisticated risk assessment algorithms that dynamically adjust the number and type of biometric modalities required based on comprehensive real-time analysis beyond simple transaction amounts. User location analysis utilizes GPS coordinates, network location data, and geofencing capabilities to assess transaction risk based on geographic patterns and known secure locations. Time-of-day analysis evaluates transaction timing against historical user patterns and institutional operating hours to identify potentially suspicious activity. Device proximity detection utilizes wireless signal analysis and environmental sensors to verify that transactions are occurring in expected physical locations relative to banking infrastructure. Risk factors are combined with transaction parameters to create dynamic authentication requirements that adapt to changing security conditions while maintaining user convenience for routine operations.

The tiered security manager 150 enables dynamic security level adjustment based on transaction parameters and user-defined policies to provide adaptive protection for cryptocurrency operations. The tiered security manager 150 includes a transaction analyzer 152, a security policy engine 154, a dynamic threshold processor 156, and an escalation protocol 158. The tiered security architecture incorporates advanced machine learning algorithms that continuously adapt security thresholds based on comprehensive analysis of historical user behavior, attempted transaction patterns, and environmental context. Behavioral analysis algorithms learn individual user patterns including typical transaction amounts, timing preferences, and biometric presentation characteristics to establish personalized security baselines. Transaction pattern recognition identifies anomalous activities that deviate from established user profiles, automatically escalating security requirements for suspicious transactions. Environmental context analysis processes data from multiple sensors and external sources to assess the overall security environment and adjust authentication requirements accordingly. The machine learning system continuously updates its models based on new data while maintaining privacy protection and preventing adversarial attacks on the learning algorithms.

The transaction analyzer 152 evaluates cryptocurrency transaction amounts and types in real-time to determine appropriate security requirements. The security policy engine 154 maintains user-configurable rules that define authentication requirements for different transaction tiers. For example, a user may configure higher-value operations to require additional verification steps. The dynamic threshold processor 156 automatically adjusts security requirements based on transaction characteristics, user behavior patterns, and risk assessment algorithms. The escalation protocol 158 can require additional authentication factors or administrative approval for transactions exceeding predetermined security thresholds.

The cryptocurrency platform integrator 160 provides secure communication pathways between the system 130 and various cryptocurrency exchanges, wallets, blockchain networks, etc. while maintaining offline security posture of the dynamic password manager device 110. The cryptocurrency platform integrator 160 includes a secure communication protocol 162, a multi-platform account manager 164, a transaction processing interface 166, and a financial system interface 168. The secure communication protocol 162 enables encrypted data exchange between banking infrastructure and cryptocurrency platforms without exposing sensitive authentication credentials. The multi-platform account manager 164 coordinates access across different cryptocurrency services while maintaining unified security policies and authentication requirements. The transaction processing interface 166 facilitates cryptocurrency operations including transfers, trades, and account management through the integrated banking infrastructure. The financial system interface 168 enable traditional banking operations for cryptocurrency assets (e.g., lending, automated payment processing, check issuance, etc.).

Initial configuration and password setup for the dynamic password manager device 110 is initiated independently before the device is placed in the secure storage compartments 126. The user can configure their security preferences such as security features to enable for different authentication scenarios based on a level of security the user would like to implement for a transaction matching that scenario.

Setup of the dynamic password manager device 110 includes configuring biometric authentication requirements, where users can choose from multiple options including fingerprint, retinal scan, heartbeat authentication, and other security features, with the ability to stack multiple security measures in different combinations with differing authentication steps in differing orders, etc. according to preferences of the user. The onboarding process involves establishing a relationship with a participating storage facility (e.g., a banking institution, etc.).

The biometric authentication can be enhanced to include additional biometric modalities beyond fingerprint, retinal scan, and heartbeat patterns. Voice recognition capabilities utilize advanced speech pattern analysis algorithms to capture unique vocal characteristics including pitch, tone, cadence, and linguistic patterns that are difficult to replicate. Gait analysis sensors employ accelerometers and gyroscopic sensors to monitor walking patterns, stride length, and movement dynamics that provide distinctive biometric signatures. Full-body movement pattern recognition systems utilize computer vision algorithms and motion sensors to analyze posture, gesture patterns, and behavioral biometrics that enhance the overall authentication framework. These additional modalities can be implemented individually or in combination with the existing biometric sensors to create more robust multi-modal authentication systems that adapt to user preferences and security requirements.

To access the dynamic password manager device 110, the user approaches the biometric access terminal 128 and provides transaction details and requested authentication information (e.g., biometric inputs, passcode inputs, etc.) to initiate access.

The biometric access terminal 128 serves as the interface between the user and their stored dynamic password manager device 110 without requiring the dynamic password manager device 110 to be physically removed from a corresponding compartment of the secure storage compartments 126. Users can independently access their devices through the biometric access terminal 128 interface.

When the user initiates access through the terminal, the system activates the multi-modal biometric authenticator 140. The biometric access terminal 128 coordinates with the biometric sensors within the stored dynamic password manager device 110 to perform this authentication. For example, the biometric access terminal 128 may request a fingerprint input from the user to determine it is a match to a fingerprint captured using a fingerprint scanner of the dynamic password manager device 110, etc. The biometric access terminal 128 accommodates different authentication configurations based on user preferences and includes sensors like those present in the dynamic password manager device 110 so that comparisons can be made for authentication. When biometric authentication is successful, dynamic password generation is activated. The dynamically created password is temporarily displayed via the biometric access terminal 128 to facilitate the user to view the current dynamic password for a configured time period.

When a user initiates a cryptocurrency transaction, the request flows from the cryptocurrency platform integrator 160 through the secure communication network 122 to the secure storage infrastructure 124. The biometric access terminal 128 activates the stored dynamic password manager device 110 and begins the authentication sequence by engaging the multi-modal biometric authenticator 140.

The biometric sensors within the dynamic password manager device 110 simultaneously collect authentication data that flows to the biometric fusion processor 148 for real-time analysis and decision-making. The tiered security manager 150 receives transaction parameters from the cryptocurrency platform integrator 160 and processes this information through the transaction analyzer 152 and security policy engine 154 to determine a required authentication level.

Based on the security requirements determined by the dynamic threshold processor 156, additional biometric factors may be requested, or the request may be escalated according to the escalation protocol 158 (e.g., for high-value transactions, etc.). Once authentication is successful, the secure cryptographic processor 118 within the dynamic password manager device 110 generates a current dynamic password, which is displayed through the temporal display 112 for the configured time period before automatically hiding.

The authenticated transaction data flows back through the secure communication protocol 162 in the cryptocurrency platform integrator 160 to an appropriate cryptocurrency platform, enabling transaction execution while maintaining the security and offline posture of the core authentication credentials. Throughout the process, the tamper-resistant housing of the dynamic password manager device 110 continuously monitors for security threats, and the redundant storage locations ensure system availability and fault tolerance across the distributed infrastructure.

A comprehensive audit trail system records each authentication attempt, password generation event, and transaction for regulatory compliance and forensic analysis. Authentication attempt logging captures detailed information about each biometric verification including timestamp, location, success/failure status, and biometric modalities used. Password generation event recording maintains cryptographically secure logs of all dynamic password creation activities while protecting the actual password values from unauthorized access. Transaction logging provides complete records of all cryptocurrency operations including amounts, recipients, authorization methods, and completion status. The audit system implements tamper-resistant logging techniques and secure storage protocols that ensure log integrity for regulatory compliance and forensic investigation purposes.

Sophisticated redundancy protocols are used including automatic failover mechanisms, data mirroring capabilities, and secure recovery procedures to address device failures or institutional disruptions. Automatic failover systems continuously monitor device health and availability, immediately redirecting user access to backup devices when primary systems become unavailable. Data mirroring protocols ensure that all critical system information including user profiles, authentication data, and transaction logs are continuously replicated across multiple secure locations. Secure recovery procedures provide systematic approaches for restoring system functionality after failures while maintaining security and data integrity throughout the recovery process. The redundancy architecture includes both hot standby systems for immediate failover and cold backup systems for long-term disaster recovery scenarios.

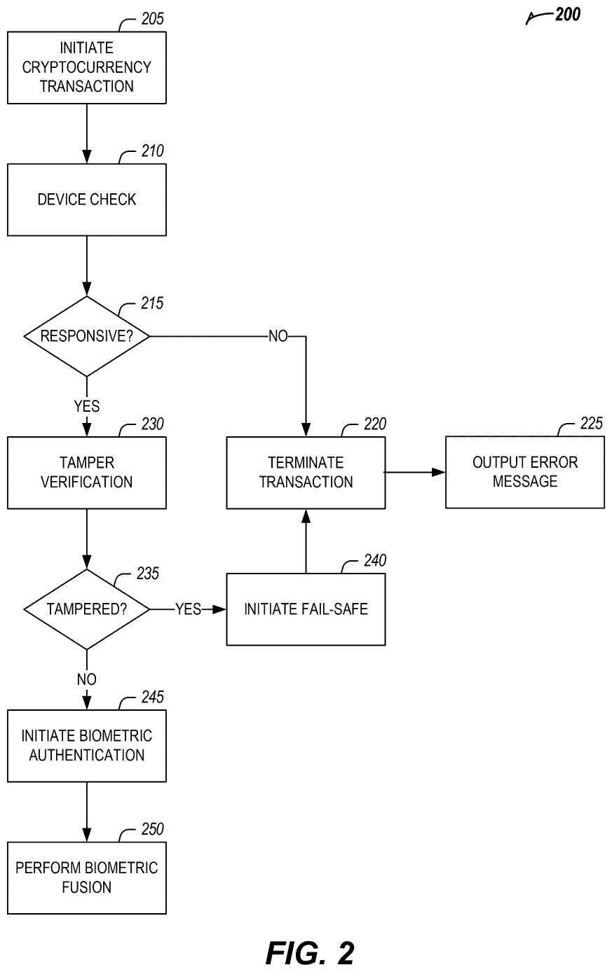

FIG. 2 illustrates a flow diagram of an example of an authentication process 200 for a physical blockchain security architecture, according to an embodiment. The authentication process 200 may provide features as described in FIG. 1.

At operation 205, a user initiates a cryptocurrency transaction. The user requests access to a cryptocurrency account through a biometric access terminal (e.g., the biometric access terminal 128 as described in FIG. 1, etc.) and transaction parameters are received that include a transaction amount and a transaction type.

At operation 210, a device activation check is performed. The biometric access terminal attempts to activate a stored dynamic password device (e.g., the dynamic password manager device 110 as described in FIG. 1, etc.).

At decision 215, it is determined if the dynamic password device is present and responsive. If it is determined at decision 215 that the dynamic password device is not present and responsive, the transaction is terminated at operation 220 and an error message is output at operation 225. If it is determined at decision 215 that the device is present and active, tamper detection is performed by a tamper-resistant housing of the dynamic password device at decision 230.

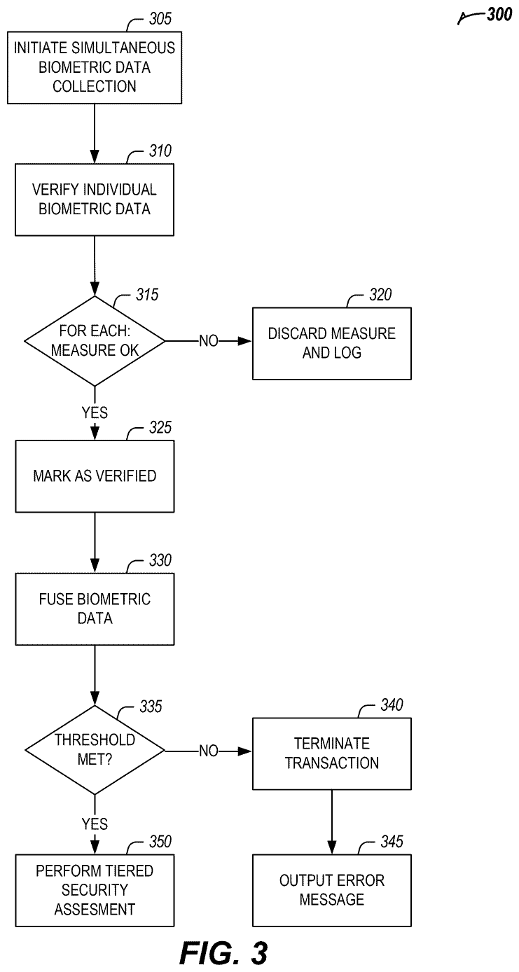

At decision 230, it is determined if the dynamic password device has been tampered with. If it is decided at decision 230 that the dynamic password device has been tampered with, fail-safe operations are initiated at operation 240, the transaction is terminated at operation 220, and an error message is output at operation 225. If it is determined at decision 230 that the dynamic password manager has not been tampered with, biometric authentication is initiated at operation 245. A multi-modal biometric authenticator (e.g., the multi-modal biometric authenticator 140 as described in FIG. 1, etc.) activates sensors in the biometric access terminal (e.g., a fingerprint scanner, a retinal scanning camera, heartbeat pattern sensor, etc. to prepare for data collection. The authentication process 200 proceeds to performance of biometric fusion at operation 250 (e.g., as shown in FIG. 3).

FIG. 3 illustrates a flow diagram of an example of a biometric fusion process 300 for a physical blockchain security architecture, according to an embodiment. The biometric fusion process 300 may provide features as described in FIGS. 1 and 2.

At operation 305, simultaneous biometric data collection is initiated. For example, a fingerprint scanner may capture minutiae patterns, a retinal scanning camera may capture vascular patterns, a heartbeat pattern sensor may monitor cardiac rhythm signatures, etc. At operation 310, individual biometric authentication measures are verified. At decision 315, it is determined for each biometric measure, in parallel or serially, that each biometric measure is valid (e.g., that it matches a reference biometric measure from the dynamic password manager device 110, etc.). If it is determined that a measure is not valid, it is discarded and logged at operation 320. If a biometric measure is determined to be valid, it is marked as verified at operation 325.

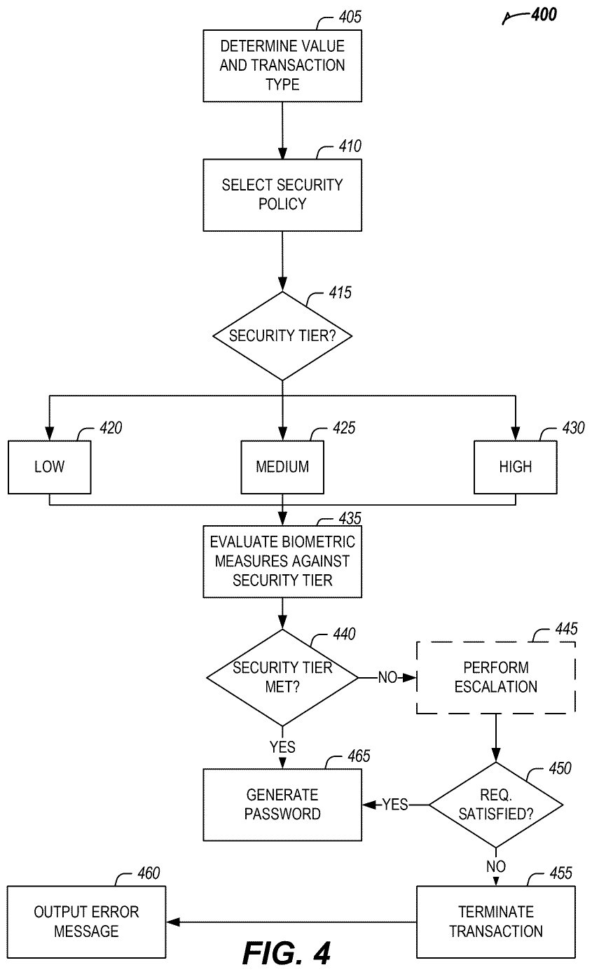

At operation 330, the biometric data is fused by a biometric fusion processor (e.g., the biometric fusion processor 148 as described in FIG. 1, etc.) analyzes the verified biometric measures. User-configured security requirements are evaluated to determine, at decision 335, if the verified biometric measures meet a minimum-security threshold? For example, a user policy is set that requires a valid fingerprint and a valid retina, at decision 335 it will be determined if a valid fingerprint and a valid retina have been collected. If the biometric measures are determined not to meet the minimum-security threshold at decision 335, the transaction is terminated at operation 340 and an error message is output at operation 345. In an example, rather than terminating the transaction at operation 340, the biometric fusion process 300 may return to operation 305 and request additional user inputs. If it is determined at decision 335 that the biometric measures meet the minimum-security threshold, a tiered security assessment is performed at operation 350 (e.g., as shown in FIG. 4).

FIG. 4 illustrates a flow diagram of an example of a tiered security assessment process 400 for a physical blockchain security architecture, according to an embodiment. The tiered security assessment process 400 may provide features as described in FIGS. 1 to 3.

At operation 405, a transaction analyzer (e.g., transaction analyzer 152 as described in FIG. 1, etc.) evaluates a value of a cryptocurrency transaction and transaction type of the cryptocurrency transaction. At operation 410, a security policy is selected based on the value and the type of the transaction. A security policy engine (e.g., the security policy engine 154 as described in FIG. 1, etc.) retrieve user-configured rules and a dynamic threshold processor (e.g., the dynamic threshold processor 156 as described in FIG. 1, etc.) assess transaction against security policies.

At decision 415, a security tier is determined using the selected security policy. For example, a low tier operation 420 may be determined to be the appropriate security tier for the transaction where basic biometric authentication is sufficient, a medium tier operation 425 may be determined to be the appropriate security tier for the transaction where enhanced verification is required for the transaction, and a high tier operation 430 may be determined to be the appropriate security tier for the transaction where maximum security protocols are required for the transaction.

At operation 435, available biometric measures are evaluated to determine, at decision 440, if the determined security tier has been met. For example, for the low tier operation 420 may verify a single biometric modality matches that of a dynamic password device (e.g., a fingerprint match, etc.), for the medium tier operation 425 multiple biometric factors may be verified (e.g., a fingerprint match and one additional biometric measure match, etc.), and for the high tier operation 430 all available biometric factors must be verified (e.g., fingerprint match, retinal match, and heartbeat pattern match, etc.).

If it is determined at decision 440 that the security tier requirements are not met, escalation may be performed at operation 445. For example, administrative approval may be required for high-value transactions, additional time delays or cooling-off periods may be implemented, etc. In an example, rather than performing escalation, the user may be prompted for additional inputs. If it is determined that the escalation requirements were not satisfied, the transaction is terminated at operation 455 and an error message is output at operation 460.

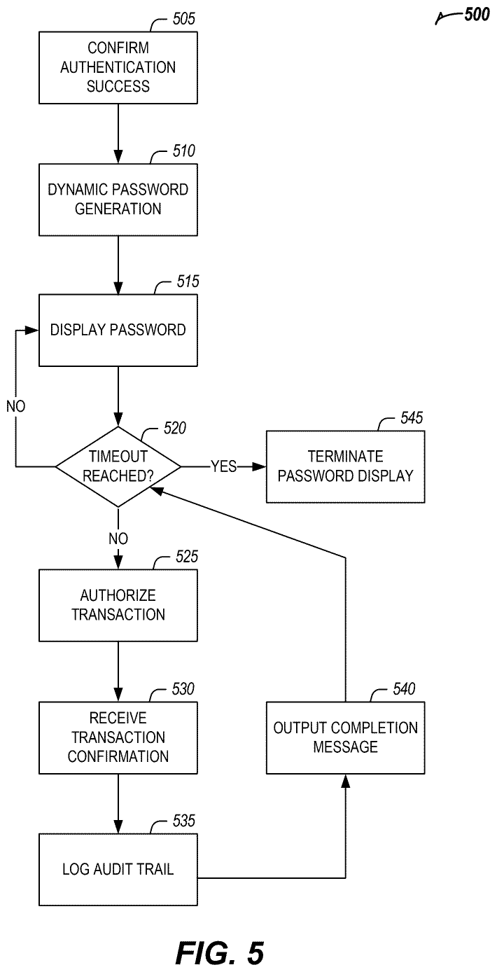

If it is determined at decision 440 that the security tier requirements have been met or if it is determined that the escalation requirements have been met at decision 450, a password is generated using the available biometric information at operation 465 (e.g., as shown in FIG. 5, etc.).

FIG. 5 illustrates a flow diagram of an example of a password generation and display process 500 for a physical blockchain security architecture, according to an embodiment. The password generation and display process 500 may provide features as described in FIGS. 1 to 4.

At operation 505, it is confirmed that authentication was successful by confirming that biometric and security tier requirements have been satisfied and that the user has authorization to complete the transaction. At operation 510, a dynamic password is generated. A secure cryptographic processor (e.g., the secure cryptographic processor 118 as described in FIG. 1, etc.) generates a current dynamic password. The password changes periodically based on time-based algorithms and encrypted storage mechanisms protect the password during generation.

At operation 515, a temporal display (e.g., the temporal display 112 as described in FIG. 1, etc.) is activated. The temporal display presents the current dynamic password to the user for a period of time configured by the user. In an example, the period of time may vary based on a security tier for the transaction. At decision 520 it is determined if a display timeout value has been reached. For example, if the display timeout value is set to sixty seconds, it is determined if sixty seconds has elapsed since the current dynamic password was initially displayed. If the timeout is determined to have been reached at decision 520, the password display is terminated at operation 545. In an example, the password may have a same or similar timeout value that, when reached, causes the password to expire. If it is determined at decision 520 that the display timeout value has not been reached, the transaction is authorized at operation 525 and the password continues to be displayed at operation 515. In an example, a countdown timer may be presented in the temporal display that provides a visual representation of the remaining display time for the current dynamic password. At operation 525, the user utilizes the displayed password for a cryptocurrency transaction and the transaction is processed through a cryptocurrency platform integrator (e.g., the cryptocurrency platform integrator 160 as described in FIG. 1, etc.) using a secure communication protocol (e.g., the secure communication protocol 162 as described in FIG. 1, etc.) to handle transaction data.

At operation 530, a transaction confirmation message is received via the cryptocurrency platform integrator. At operation 535, details of the transaction are logged by a financial institution facilitating the transaction to create an audit trail. At operation 540, a message is transmitted to the user (e.g., via a secure device, via a biometric access terminal used to initiate authentication, etc.). At decision 520 it is decided if the password timeout has been reached. If so, the password display is terminated at operation 545 and the dynamic password device is idled. If the password timeout has not elapsed, the password may continue to be displayed. In an example, the password display may cease upon receipt of the successful transaction confirmation at operation 530.

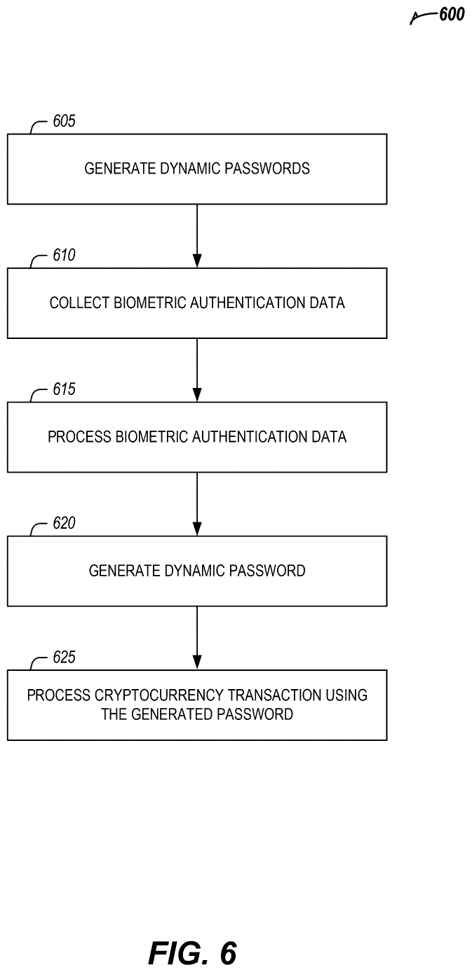

FIG. 6 illustrates an example of a method for physical blockchain security architecture, according to an embodiment. The method 600 may provide features as described in FIGS. 1 to 5.

At operation 605 a secure cryptographic processor within a tamper-resistant hardware device generates dynamic passwords at predetermined time intervals while maintaining encrypted storage of authentication credentials. In an example, the hardware device may be accessed via a biometric access terminal while the hardware device is stored in a secure storage compartment of a secure storage facility.

At operation 610, multiple integrated biometric sensors within the hardware device simultaneously collect biometric authentication data from a plurality of biometric modalities. In an example, the collected biometric authentication data comprises at least a fingerprint pattern and a retinal vascular pattern.

At operation 615, a biometric fusion processor processes the collected biometric authentication data using real-time algorithms to generate a unified authentication decision based on user-configurable security thresholds. In an example, the biometric authentication data comprises heartbeat pattern recognition, and the biometric fusion processor implements adaptive threshold algorithms that adjust authentication requirements based on cryptocurrency transaction amounts. In an example, a tiered security architecture is applied to dynamically adjust authentication requirements based on real-time analysis of parameters of the cryptocurrency transaction.

At operation 620, a generated dynamic password is displayed on a display for a configurable time period before automatically hiding the dynamic password based on the unified authentication decision. In an example, hierarchical key derivation functions are applied to generate the dynamic password as a time-based password from a master seed stored in the secure cryptographic processor of the hardware device and the dynamic password is generated using a cryptographically secure algorithm to prevent replay attacks. At operation 625, a cryptocurrency transaction is processed via a secure communication protocol using the generated dynamic password. In an example, encrypted authentication state information associated with the hardware device is synchronized across multiple redundant secure storage locations across different geographic regions. In an example, a spliced key architecture is applied wherein cryptocurrency private key information is divided into encrypted portions stored separately on the hardware device and biometric authentication infrastructure, and wherein processing the cryptocurrency transaction uses a temporary pairing of the encrypted portions through a decoding algorithm.

In an example, the hardware device is automatically disabled upon detection of unauthorized physical manipulation of the hardware device by a tamper detection mechanism within the hardware device or detection of unauthorized removal of the hardware device from a secure environment by the tamper detection mechanism. In an example, the tamper detection mechanism comprises an environmental monitoring sensor that detects changes in electromagnetic fields, temperature variations, and physical displacement and automatically disables the hardware device by destroying a cryptographic key of the hardware device and erasing a memory of the hardware device.

FIG. 7A and FIG. 7B illustrate an example of a secure hardware device 700 for a physical blockchain security architecture, according to an embodiment. The secure hardware device 700 may provide features as described in FIGS. 1 to 6.

As shown in FIG. 7A, a front of the example secure hardware device 700 includes a variety of physical sensors that include, a display device 705, an eye scanning sensor 710 (e.g., a retinal scanner, etc.), a fingerprint scanning sensor 715, and a camera device 720. The display device 705 outputs a temporary password and a time to live value of the temporary password. Additional or alternative output may be displayed on the display device 705 according to functions being performed. The variety of physical sensors are used to collect reference biometric data for a user and to validate biometric data of an individual attempting to access the secure hardware device 700 and data contained therein.

As shown in FIG. 7B, a back of the example secure hardware device 700 includes a keypad 730 (e.g., a physical keypad, a touch-sensitive display, etc.), a security level selection element 735 (e.g., physical buttons, touch-sensitive display, etc.), and a power, charging, and data transfer port 740 (e.g., universal serial bus type C port, etc.). The secure hardware device 700 includes a replaceable battery that may be recharged or may be disposable. In the case of a chargeable battery, the battery can be charged by the power, charging, and data transfer port 740. The secure hardware device 700 can be directly powered by the power, charging, and data transfer port 740 when it is docked in a secure storage facility. It will be understood that other power technologies such as magnetic resonance, etc. can be used to power the device. The keypad 730 is accessed by the user to enter numerical data and navigate menus and prompts output on the display device 705 or directly on the keypad 730. The security level selection element 735 is accessed by the user to select a security level for a context (e.g., tier 1, tier 2, tier 3, etc.). The security levels indicate ascending and descending security check integrity. For example, a tier 1 security level may request collection of one biometric measurement while a tier 3 security level may request collection of three biometric measures and a password.

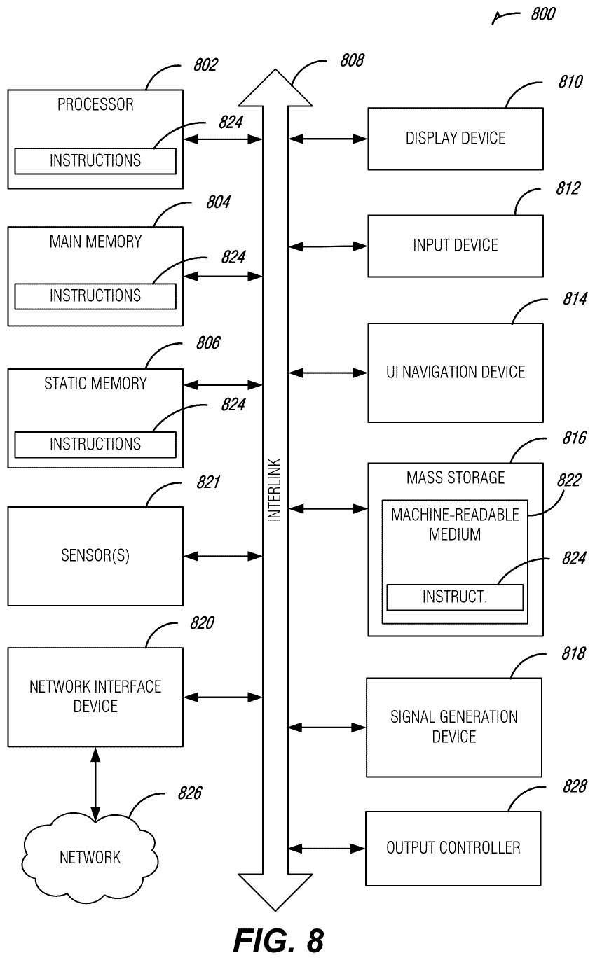

FIG. 8 illustrates a block diagram of an example machine 800 upon which any one or more of the techniques (e.g., methodologies) discussed herein may perform. In alternative embodiments, the machine 800 may operate as a standalone device or may be connected (e.g., networked) to other machines. In a networked deployment, the machine 800 may operate in the capacity of a server machine, a client machine, or both in server-client network environments. In an example, the machine 800 may act as a peer machine in peer-to-peer (P2P) (or other distributed) network environment. The machine 800 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate by, logic or a number of components, or mechanisms. Circuit sets are a collection of circuits implemented in tangible entities that include hardware (e.g., simple circuits, gates, logic, etc.). Circuit set membership may be flexible over time and underlying hardware variability. Circuit sets include members that may, alone or in combination, perform specified operations when operating. In an example, hardware of the circuit set may be immutably designed to carry out a specific operation (e.g., hardwired). In an example, the hardware of the circuit set may include variably connected physical components (e.g., execution units, transistors, simple circuits, etc.) including a computer readable medium physically modified (e.g., magnetically, electrically, moveable placement of invariant massed particles, etc.) to encode instructions of the specific operation. In connecting the physical components, the underlying electrical properties of a hardware constituent are changed, for example, from an insulator to a conductor or vice versa. The instructions enable embedded hardware (e.g., the execution units or a loading mechanism) to create members of the circuit set in hardware via the variable connections to carry out portions of the specific operation when in operation. Accordingly, the computer readable medium is communicatively coupled to the other components of the circuit set member when the device is operating. In an example, any of the physical components may be used in more than one member of more than one circuit set. For example, under operation, execution units may be used in a first circuit of a first circuit set at one point in time and reused by a second circuit in the first circuit set, or by a third circuit in a second circuit set at a different time.

Machine 800 (e.g., computer system) may include a hardware processor 802 (e.g., a central processing unit (CPU), a graphics processing unit (GPU), a hardware processor core, or any combination thereof), a main memory 804 and a static memory 806, some or all of which may communicate with each other via an interlink (e.g., bus) 808. The machine 800 may further include a display unit 810, an alphanumeric input device 812 (e.g., a keyboard), and a user interface (UI) navigation device 814 (e.g., a mouse). In an example, the display unit 810, alphanumeric input device 812, and UI navigation device 814 may be a touch screen display. The machine 800 may additionally include a storage device 816 (e.g., drive unit), a signal generation device 818 (e.g., a speaker), a network interface device 820, and one or more sensors 821, such as a global positioning system (GPS) sensor, compass, accelerometer, or other sensors. The machine 800 may include an output controller 828, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 816 may include a machine readable medium 822 on which is stored one or more sets of data structures or instructions 824 (e.g., software) embodying or utilized by any one or more of the techniques or functions described herein. The instructions 824 may also reside, completely or at least partially, within the main memory 804, within static memory 806, or within the hardware processor 802 during execution thereof by the machine 800. In an example, one or any combination of the hardware processor 802, the main memory 804, the static memory 806, or the storage device 816 may constitute machine readable media.

While the machine readable medium 822 is illustrated as a single medium, the term “machine readable medium” may include a single medium or multiple media (e.g., a centralized or distributed database, and/or associated caches and servers) configured to store the instructions 824.

The term “machine readable medium” may include any medium that is capable of storing, encoding, or carrying instructions for execution by the machine 800 and that cause the machine 800 to perform any one or more of the techniques of the present disclosure, or that is capable of storing, encoding or carrying data structures used by or associated with such instructions. Non-limiting machine readable medium examples may include solid-state memories, and optical and magnetic media. In an example, machine readable media may exclude transitory propagating signals (e.g., non-transitory machine-readable storage media). Specific examples of non-transitory machine-readable storage media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 824 may further be transmitted or received over a communications network 826 using a transmission medium via the network interface device 820 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, LoRa®/LoRaWAN® LPWAN standards, etc.), IEEE 802.15.4 family of standards, peer-to-peer (P2P) networks, 3^{rd} Generation Partnership Project (3GPP) standards for 4G and 5G wireless communication including: 3GPP Long-Term evolution (LTE) family of standards, 3GPP LTE Advanced family of standards, 3GPP LTE Advanced Pro family of standards, 3GPP New Radio (NR) family of standards, among others. In an example, the network interface device 820 may include one or more physical jacks (e.g., Ethernet, coaxial, or phone jacks) or one or more antennas to connect to the communications network 826. In an example, the network interface device 820 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 800, and includes digital or analog communications signals or other intangible medium to facilitate communication of such software.

### Additional Notes & Examples

Example 1 is a system for securing cryptocurrency transactions, comprising: at least one processor; and memory comprising instructions that, when executed by the at least one processor, cause the at least one processor to perform operations to: generate, by a secure cryptographic processor within a tamper-resistant hardware device, dynamic passwords at predetermined time intervals while maintaining encrypted storage of authentication credentials; simultaneously collect, by multiple integrated biometric sensors within the hardware device, biometric authentication data from a plurality of biometric modalities; process, by a biometric fusion processor, the collected biometric authentication data using real-time algorithms to generate a unified authentication decision based on user-configurable security thresholds; display a generated dynamic password, based on the unified authentication decision, on a display for a configurable time period before automatically hiding the dynamic password; and process a cryptocurrency transaction via a secure communication protocol using the generated dynamic password.

In Example 2, the subject matter of Example 1 includes, wherein the collected biometric authentication data comprises at least a fingerprint pattern and a retinal vascular pattern.

In Example 3, the subject matter of Examples 1-2 includes, the memory further comprising instructions that, when executed by the at least one processor, cause the at least one processor to perform operations to access the hardware device via a biometric access terminal while the hardware device is stored in a secure storage compartment of a secure storage facility.

In Example 4, the subject matter of Examples 1-3 includes, wherein the biometric authentication data comprises heartbeat pattern recognition, and wherein the biometric fusion processor implements adaptive threshold algorithms that adjust authentication requirements based on cryptocurrency transaction amounts.

In Example 5, the subject matter of Examples 1-4 includes, the instructions to generate the dynamic password further comprising instructions to apply hierarchical key derivation functions to generate the dynamic password as a time-based password from a master seed stored in the secure cryptographic processor of the hardware device, wherein the dynamic password is generated using a cryptographically secure algorithm to prevent replay attacks.

In Example 6, the subject matter of Examples 1-5 includes, the memory further comprising instructions that, when executed by the at least one processor, cause the at least one processor to perform operations to automatically disable the hardware device upon detection of unauthorized physical manipulation of the hardware device by a tamper detection mechanism within the hardware device or detection of unauthorized removal of the hardware device from a secure environment by the tamper detection mechanism.

In Example 7, the subject matter of Example 6 includes, wherein the tamper detection mechanism comprises an environmental monitoring sensor that detects changes in electromagnetic fields, temperature variations, and physical displacement, and the instructions to automatically disable the hardware device further comprising instructions to destroy a cryptographic key of the hardware device and erase a memory of the hardware device.

In Example 8, the subject matter of Examples 1-7 includes, the memory further comprising instructions that, when executed by the at least one processor, cause the at least one processor to perform operations to apply a tiered security architecture to dynamically adjust authentication requirements based on real-time analysis of parameters of the cryptocurrency transaction.

In Example 9, the subject matter of Examples 1-8 includes, the memory further comprising instructions that, when executed by the at least one processor, cause the at least one processor to perform operations to synchronize encrypted authentication state information associated with the hardware device across multiple redundant secure storage locations across different geographic regions.

In Example 10, the subject matter of Examples 1-9 includes, the memory further comprising instructions that, when executed by the at least one processor, cause the at least one processor to perform operations to apply a spliced key architecture wherein cryptocurrency private key information is divided into encrypted portions stored separately on the hardware device and biometric authentication infrastructure, and wherein processing the cryptocurrency transaction uses a temporary pairing of the encrypted portions through a decoding algorithm.

Example 11 is at least one non-transitory machine-readable medium comprising instructions for securing cryptocurrency transactions that, when executed by at least one processor, cause the at least one processor to perform operations to: generate, by a secure cryptographic processor within a tamper-resistant hardware device, dynamic passwords at predetermined time intervals while maintaining encrypted storage of authentication credentials; simultaneously collect, by multiple integrated biometric sensors within the hardware device, biometric authentication data from a plurality of biometric modalities; process, by a biometric fusion processor, the collected biometric authentication data using real-time algorithms to generate a unified authentication decision based on user-configurable security thresholds; display a generated dynamic password, based on the unified authentication decision, on a display for a configurable time period before automatically hiding the dynamic password; and process a cryptocurrency transaction via a secure communication protocol using the generated dynamic password.

In Example 12, the subject matter of Example 11 includes, wherein the collected biometric authentication data comprises at least a fingerprint pattern and a retinal vascular pattern.

In Example 13, the subject matter of Examples 11-12 includes, instructions that, when executed by the at least one processor, cause the at least one processor to perform operations to access the hardware device via a biometric access terminal while the hardware device is stored in a secure storage compartment of a secure storage facility.

In Example 14, the subject matter of Examples 11-13 includes, wherein the biometric authentication data comprises heartbeat pattern recognition, and wherein the biometric fusion processor implements adaptive threshold algorithms that adjust authentication requirements based on cryptocurrency transaction amounts.

In Example 15, the subject matter of Examples 11-14 includes, the instructions to generate the dynamic password further comprising instructions to apply hierarchical key derivation functions to generate the dynamic password as a time-based password from a master seed stored in the secure cryptographic processor of the hardware device, wherein the dynamic password is generated using a cryptographically secure algorithm to prevent replay attacks.

In Example 16, the subject matter of Examples 11-15 includes, instructions that, when executed by the at least one processor, cause the at least one processor to perform operations to automatically disable the hardware device upon detection of unauthorized physical manipulation of the hardware device by a tamper detection mechanism within the hardware device or detection of unauthorized removal of the hardware device from a secure environment by the tamper detection mechanism.

In Example 17, the subject matter of Example 16 includes, wherein the tamper detection mechanism comprises an environmental monitoring sensor that detects changes in electromagnetic fields, temperature variations, and physical displacement, and the instructions to automatically disable the hardware device further comprising instructions to destroy a cryptographic key of the hardware device and erase a memory of the hardware device.

In Example 18, the subject matter of Examples 11-17 includes, instructions that, when executed by the at least one processor, cause the at least one processor to perform operations to apply a tiered security architecture to dynamically adjust authentication requirements based on real-time analysis of parameters of the cryptocurrency transaction.

In Example 19, the subject matter of Examples 11-18 includes, instructions that, when executed by the at least one processor, cause the at least one processor to perform operations to synchronize encrypted authentication state information associated with the hardware device across multiple redundant secure storage locations across different geographic regions.

In Example 20, the subject matter of Examples 11-19 includes, instructions that, when executed by the at least one processor, cause the at least one processor to perform operations to apply a spliced key architecture wherein cryptocurrency private key information is divided into encrypted portions stored separately on the hardware device and biometric authentication infrastructure, and wherein processing the cryptocurrency transaction uses a temporary pairing of the encrypted portions through a decoding algorithm.

Example 21 is a computer-implemented method for securing cryptocurrency transactions, comprising: generating, by a secure cryptographic processor within a tamper-resistant hardware device, dynamic passwords at predetermined time intervals while maintaining encrypted storage of authentication credentials; simultaneously collecting, by multiple integrated biometric sensors within the hardware device, biometric authentication data from a plurality of biometric modalities; processing, by a biometric fusion processor, the collected biometric authentication data using real-time algorithms to generate a unified authentication decision based on user-configurable security thresholds; displaying a generated dynamic password, based on the unified authentication decision, on a display for a configurable time period before automatically hiding the dynamic password; and processing a cryptocurrency transaction via a secure communication protocol using the generated dynamic password.

In Example 22, the subject matter of Example 21 includes, wherein the collected biometric authentication data comprises at least a fingerprint pattern and a retinal vascular pattern.

In Example 23, the subject matter of Examples 21-22 includes, accessing the hardware device via a biometric access terminal while the hardware device is stored in a secure storage compartment of a secure storage facility.

In Example 24, the subject matter of Examples 21-23 includes, wherein the biometric authentication data comprises heartbeat pattern recognition, and wherein the biometric fusion processor implements adaptive threshold algorithms that adjust authentication requirements based on cryptocurrency transaction amounts.

In Example 25, the subject matter of Examples 21-24 includes, wherein generating the dynamic password comprises applying hierarchical key derivation functions to generate the dynamic password as a time-based password from a master seed stored in the secure cryptographic processor of the hardware device, and wherein the dynamic password is generated using a cryptographically secure algorithm to prevent replay attacks.

In Example 26, the subject matter of Examples 21-25 includes, automatically disabling the hardware device upon detection of unauthorized physical manipulation of the hardware device by a tamper detection mechanism within the hardware device or detection of unauthorized removal of the hardware device from a secure environment by the tamper detection mechanism.

In Example 27, the subject matter of Example 26 includes, wherein the tamper detection mechanism comprises an environmental monitoring sensor that detects changes in electromagnetic fields, temperature variations, and physical displacement, and wherein automatically disabling the hardware device comprises cryptographic key destruction and memory erasure.

In Example 28, the subject matter of Examples 21-27 includes, applying a tiered security architecture to dynamically adjust authentication requirements based on real-time analysis of parameters of the cryptocurrency transaction.

In Example 29, the subject matter of Examples 21-28 includes, synchronizing encrypted authentication state information associated with the hardware device across multiple redundant secure storage locations across different geographic regions.

In Example 30, the subject matter of Examples 21-29 includes, applying a spliced key architecture wherein cryptocurrency private key information is divided into encrypted portions stored separately on the hardware device and biometric authentication infrastructure, and wherein processing the cryptocurrency transaction uses a temporary pairing of the encrypted portions through a decoding algorithm.

Example 31 is at least one machine-readable medium including instructions that, when executed by processing circuitry, cause the processing circuitry to perform operations to implement of any of Examples 1-30.

Example 32 is an apparatus comprising means to implement of any of Examples 1-30.

Example 33 is a system to implement of any of Examples 1-30.

Example 34 is a method to implement of any of Examples 1-30.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) may be used in combination with each other. Other embodiments may be used, such as by one of ordinary skill in the art upon reviewing the above description. The Abstract is to allow the reader to quickly ascertain the nature of the technical disclosure and is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment. The scope of the embodiments should be determined with reference to the appended claims, along with the full scope of equivalents to which such claims are entitled.

What is claimed is:

1. A system for securing cryptocurrency transactions, comprising:
at least one processor; and
memory comprising instructions that, when executed by the at least one processor, cause the at least one processor to perform operations to:
generate, by a secure cryptographic processor within a tamper-resistant hardware device, dynamic passwords at predetermined time intervals while maintaining encrypted storage of authentication credentials;
simultaneously collect, by multiple integrated biometric sensors within the tamper-resistant hardware device, biometric authentication data from a plurality of biometric modalities;
process, by a biometric fusion processor, the collected biometric authentication data using real-time algorithms to generate a unified authentication decision based on user-configurable security thresholds;
display a generated dynamic password, based on the unified authentication decision, on a display for a configurable time period before automatically hiding the generated dynamic password; and
process a cryptocurrency transaction via a secure communication protocol using the generated dynamic password.

2. The system of claim 1, wherein the collected biometric authentication data comprises at least a fingerprint pattern and a retinal vascular pattern.

3. The system of claim 1, the memory further comprising instructions that, when executed by the at least one processor, cause the at least one processor to perform operations to access the tamper-resistant hardware device via a biometric access terminal while the tamper-resistant hardware device is stored in a secure storage compartment of a secure storage facility.

4. The system of claim 1, wherein the biometric authentication data comprises heartbeat pattern recognition, and wherein the biometric fusion processor implements adaptive threshold algorithms that adjust authentication requirements based on cryptocurrency transaction amounts.

5. The system of claim 1, the instructions to generate the generated dynamic password further comprising instructions to apply hierarchical key derivation functions to generate the generated dynamic password as a time-based password from a master seed stored in the secure cryptographic processor of the tamper-resistant hardware device, wherein the generated dynamic password is generated using a cryptographically secure algorithm to prevent replay attacks.

6. The system of claim 1, the memory further comprising instructions that, when executed by the at least one processor, cause the at least one processor to perform operations to automatically disable the tamper-resistant hardware device upon detection of unauthorized physical manipulation of the tamper-resistant hardware device by a tamper detection mechanism within the tamper-resistant hardware device or detection of unauthorized removal of the tamper-resistant hardware device from a secure environment by the tamper detection mechanism.

7. The system of claim 6, wherein the tamper detection mechanism comprises an environmental monitoring sensor that detects changes in electromagnetic fields, temperature variations, and physical displacement, and the instructions to automatically disable the tamper-resistant hardware device further comprising instructions to destroy a cryptographic key of the tamper-resistant hardware device and erase a memory of the tamper-resistant hardware device.

8. The system of claim 1, the memory further comprising instructions that, when executed by the at least one processor, cause the at least one processor to perform operations to apply a tiered security architecture to dynamically adjust authentication requirements based on real-time analysis of parameters of the cryptocurrency transaction.

9. The system of claim 1, the memory further comprising instructions that, when executed by the at least one processor, cause the at least one processor to perform operations to synchronize encrypted authentication state information associated with the tamper-resistant hardware device across multiple redundant secure storage locations across different geographic regions.

10. The system of claim 1, the memory further comprising instructions that, when executed by the at least one processor, cause the at least one processor to perform operations to apply a spliced key architecture wherein cryptocurrency private key information is divided into encrypted portions stored separately on the tamper-resistant hardware device and biometric authentication infrastructure, and wherein processing the cryptocurrency transaction uses a temporary pairing of the encrypted portions through a decoding algorithm.

11. At least one non-transitory machine-readable medium comprising instructions for securing cryptocurrency transactions that, when executed by at least one processor, cause the at least one processor to perform operations to:
generate, by a secure cryptographic processor within a tamper-resistant hardware device, dynamic passwords at predetermined time intervals while maintaining encrypted storage of authentication credentials;
simultaneously collect, by multiple integrated biometric sensors within the tamper-resistant hardware device, biometric authentication data from a plurality of biometric modalities;
process, by a biometric fusion processor, the collected biometric authentication data using real-time algorithms to generate a unified authentication decision based on user-configurable security thresholds;
display a generated dynamic password, based on the unified authentication decision, on a display for a configurable time period before automatically hiding the generated dynamic password; and
process a cryptocurrency transaction via a secure communication protocol using the generated dynamic password.

12. The at least one non-transitory machine-readable medium of claim 11, wherein the collected biometric authentication data comprises at least a fingerprint pattern and a retinal vascular pattern.

13. The at least one non-transitory machine-readable medium of claim 11, further comprising instructions that, when executed by the at least one processor, cause the at least one processor to perform operations to access the tamper-resistant hardware device via a biometric access terminal while the tamper-resistant hardware device is stored in a secure storage compartment of a secure storage facility.

14. The at least one non-transitory machine-readable medium of claim 11, wherein the biometric authentication data comprises heartbeat pattern recognition, and wherein the biometric fusion processor implements adaptive threshold algorithms that adjust authentication requirements based on cryptocurrency transaction amounts.

15. The at least one non-transitory machine-readable medium of claim 11, the instructions to generate the generated dynamic password further comprising instructions to apply hierarchical key derivation functions to generate the generated dynamic password as a time-based password from a master seed stored in the secure cryptographic processor of the tamper-resistant hardware device, wherein the generated dynamic password is generated using a cryptographically secure algorithm to prevent replay attacks.

16. The at least one non-transitory machine-readable medium of claim 11, further comprising instructions that, when executed by the at least one processor, cause the at least one processor to perform operations to automatically disable the tamper-resistant hardware device upon detection of unauthorized physical manipulation of the tamper-resistant hardware device by a tamper detection mechanism within the tamper-resistant hardware device or detection of unauthorized removal of the tamper-resistant hardware device from a secure environment by the tamper detection mechanism.

17. The at least one non-transitory machine-readable medium of claim 16, wherein the tamper detection mechanism comprises an environmental monitoring sensor that detects changes in electromagnetic fields, temperature variations, and physical displacement, and the instructions to automatically disable the tamper-resistant hardware device further comprising instructions to destroy a cryptographic key of the tamper-resistant hardware device and erase a memory of the tamper-resistant hardware device.

18. The at least one non-transitory machine-readable medium of claim 11, further comprising instructions that, when executed by the at least one processor, cause the at least one processor to perform operations to apply a tiered security architecture to dynamically adjust authentication requirements based on real-time analysis of parameters of the cryptocurrency transaction.

19. The at least one non-transitory machine-readable medium of claim 11, further comprising instructions that, when executed by the at least one processor, cause the at least one processor to perform operations to synchronize encrypted authentication state information associated with the tamper-resistant hardware device across multiple redundant secure storage locations across different geographic regions.

20. The at least one non-transitory machine-readable medium of claim 11, further comprising instructions that, when executed by the at least one processor, cause the at least one processor to perform operations to apply a spliced key architecture wherein cryptocurrency private key information is divided into encrypted portions stored separately on the tamper-resistant hardware device and biometric authentication infrastructure, and wherein processing the cryptocurrency transaction uses a temporary pairing of the encrypted portions through a decoding algorithm.

21. A computer-implemented method for securing cryptocurrency transactions, comprising:
generating, by a secure cryptographic processor within a tamper-resistant hardware device, dynamic passwords at predetermined time intervals while maintaining encrypted storage of authentication credentials;
simultaneously collecting, by multiple integrated biometric sensors within the tamper-resistant hardware device, biometric authentication data from a plurality of biometric modalities;
processing, by a biometric fusion processor, the collected biometric authentication data using real-time algorithms to generate a unified authentication decision based on user-configurable security thresholds;
displaying a generated dynamic password, based on the unified authentication decision, on a display for a configurable time period before automatically hiding the generated dynamic password; and
processing a cryptocurrency transaction via a secure communication protocol using the generated dynamic password.

22. The computer-implemented method of claim 21, wherein the collected biometric authentication data comprises at least a fingerprint pattern and a retinal vascular pattern.

23. The computer-implemented method of claim 21, further comprising accessing the tamper-resistant hardware device via a biometric access terminal while the tamper-resistant hardware device is stored in a secure storage compartment of a secure storage facility.

24. The computer-implemented method of claim 21, wherein the biometric authentication data comprises heartbeat pattern recognition, and wherein the biometric fusion processor implements adaptive threshold algorithms that adjust authentication requirements based on cryptocurrency transaction amounts.

25. The computer-implemented method of claim 21, wherein generating the generated dynamic password comprises applying hierarchical key derivation functions to generate the generated dynamic password as a time-based password from a master seed stored in the secure cryptographic processor of the tamper-resistant hardware device, and wherein the generated dynamic password is generated using a cryptographically secure algorithm to prevent replay attacks.

26. The computer-implemented method of claim 21, further comprising automatically disabling the tamper-resistant hardware device upon detection of unauthorized physical manipulation of the tamper-resistant hardware device by a tamper detection mechanism within the tamper-resistant hardware device or detection of unauthorized removal of the tamper-resistant hardware device from a secure environment by the tamper detection mechanism.

27. The computer-implemented method of claim 26, wherein the tamper detection mechanism comprises an environmental monitoring sensor that detects changes in electromagnetic fields, temperature variations, and physical displacement, and wherein automatically disabling the tamper-resistant hardware device comprises cryptographic key destruction and memory erasure.

28. The computer-implemented method of claim 21, further comprising applying a tiered security architecture to dynamically adjust authentication requirements based on real-time analysis of parameters of the cryptocurrency transaction.

29. The computer-implemented method of claim 21, further comprising synchronizing encrypted authentication state information associated with the tamper-resistant hardware device across multiple redundant secure storage locations across different geographic regions.

30. The computer-implemented method of claim 21, further comprising applying a spliced key architecture wherein cryptocurrency private key information is divided into encrypted portions stored separately on the tamper-resistant hardware device and biometric authentication infrastructure, and wherein processing the cryptocurrency transaction uses a temporary pairing of the encrypted portions through a decoding algorithm.
